(19) United States
(12) Patent Application Publication
(10) Pub. No.: US 2002/0158750 A1
(43) Pub. Date: Oct. 31, 2002

(54) System, method and portable device for biometric identification

(76) Inventor: Mansour Saleh Almalik, Riyadh (SA)

Correspondence Address: FULBRIGHT & JAWORSKI, LLP, 1301 MCKINNEY, SUITE 5100, HOUSTON, TX, 77010-3095, US

(21) Appl. No.: 10/135,780

(22) Filed: Apr. 30, 2002

Related U.S. Application Data
(60) Provisional application No. 60/287,657, filed on Apr. 30, 2001.

(51) Int. Cl. G05B 19/00

(52) U.S. Cl. 340/5.83; 713/200

(57) ABSTRACT

A system, method and apparatus for biometric identification employing an iris scanning camera for biometric identification of a person. An iris scanning camera is coupled with a laptop, keyboard, or employed in portable unit. An iris pattern code for an individual is stored on a database, or other electronic media. The CPU of the portable device or a CPU of an attached or remote computer if utilizing the keyboard, converts the reading of an iris pattern into an iris pattern code. The stored iris pattern code is compared with the generated iris pattern code and a an iris pattern code match is determined.

### CROSS-REFERENCE TO RELATED APPLICATIONS

This application claims the benefit of the filing date of U.S. Provisional Application Serial No. 60/287,657 filed Apr. 30, 2001, now pending (hereby incorporated by reference for all purposes).

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The field of this invention relates generally to a system, method and device for biometric identification, and more particularly to a system, method and portable device configured for personal identification through biometric features and/or allowing video-conferencing.

2. General Background of the Invention

Iris recognition is one of the most accurate, reliable and convenient methods to authenticate the identity of a person. Various algorithms have been defined to reduce the pattern of the human iris into a code that may be used for identification of a person. For example, one algorithm for iris feature extraction, developed by Yong Zhu, Tieniu Tan and Yunhong Wang, is based on texture analysis using multi-channel Gabor filtering and wavelet transforms, employing 2-D information of the iris and is translation, rotation, and scale invariant.

Other use of iris identification is disclosed in certain patent references. U.S. Pat. No. 5,386,104 to Sime, the disclosure of which is incorporated by reference is titled “System and method for detecting user fraud in automated teller machine transactions.” The Doster reference discloses a self-service automated teller system including a fraud detection module which uses a biometric recognition technique, including iris scanning.

U.S. Pat. No. 5,956,122 to Doster, the disclosure of which is incorporated by reference, is titled “Iris recognition apparatus and method.” The Doster reference discloses an iris recognition apparatus and method including a camera for imaging the human retina as seen through the pupil. The Doster reference teaches that the reflective retina and pupil are imaged as a luminous or retro-reflective spot located in a field of view. A direction to the spot (i.e., the retina spot at the pupil within the iris) in the field of view is determined, and a fine-focus video camera is directed along this direction to capture an image of the iris surrounding the pupil of the eye. The captured iris image can be used for unique and individual identification of the human whose eye is imaged using known data storage, retrieval, and comparison methods.

U.S. Pat. No. 6,247,813 to Kim, et al., the disclosure of which is incorporated by reference, is titled “Iris identification system and method of identifying a person through iris recognition. The Kim reference discloses an iris identification system and method of identifying the identity of an animate being through iris scanning. The system features an iris system pick-up unit including a camera for capturing iris images to create input image signals. The iris image pick-up unit is operated with a control unit that is interfaced with a data processing unit for preprocessing the input image signals into processed data.

A need exists for convenient and portable devices that provide for biometric identification through iris recognition.

### SUMMARY OF THE INVENTION

The invention as described herein utilizes a camera to capture an image (the pattern) of the iris. The captured image is then processed into an iris pattern code. As used herein an iris pattern code is any value or information that identifies the pattern of the iris of a person. Additionally, biometric features include biometric information about an individual such as the iris pattern, facial bone structure physiognomy, and retna patterns. The code is matched against a pre-stored iris pattern code to authenticate the identity of a person. The conversion of the iris pattern can be done using those algorithms and processes as known to one skilled in the art. The iris pattern code is associated to the identity of the individual. Initially, the iris pattern code is generated for an individual and information associated to that individual is stored on a electronic or optical media. For example, by way of illustration, but not limitation, the electronic or optical media, may be a hard drive, smart card, or compact disc.

The personal information of an individual and iris pattern code are preferably stored in a secured encrypted manner such that the information can not be changed or manipulated without proper access or authority.

The information associated with the iris pattern code includes various data about the individual. For example, by way of illustration, but not limitation, the information may include the individuals name, date of birth, country of citizenship, gender, eye color, height, weight, ethnicity, and organizational affiliations. Additionally, such information as visa and passport expiration dates may be associated to iris pattern code.

One aspect of the invention is a miniature camera installed into a portable communications device that allows for (1) video-conferencing, and (2) personal identification through biometric features, e.g. iris scan, facial bone structure physiognomy, to allow secure access to confidential databases and transaction capabilities, e.g., e-banking and brokerage activities. The camera has several focal distances: (a) 12-24 inches for videoconferencing, and (b) 6-12 inches for facial bone structure physiognomy recognition, and (c) 1-6 inches for iris scan. Personal biometric identification features are maintained on a central database or embedded in a microchip installed in the device.

Another aspect of the invention is a portable computer, e.g., laptop computer with a miniature camera installed, that allows for (1) video-conferencing, and (2) personal identification through biometric features, e.g. iris scan, facial bone structure physiognomy, to allow secure access to confidential databases and transaction capabilities, e.g., e-banking and brokerage activities. The camera has several focal distances: (a) 12-24 inches for videoconferencing, and (b) 6-12 inches for facial bone structure physiognomy recognition, and (c) 1-6 inches for iris scan. Personal biometric identification features will be maintained on a central database or embedded in a microchip installed in the device. The computer will be equipped with a transceiver and satellite to permit transmission of communications, including videoconferencing and biometric feature identification, via satellite.

Another aspect of the invention is portable computer, e.g., laptop computer, with an installed miniature camera installed that allows for (1) video-conferencing, and (2) personal identification through biometric features, e.g. iris scan, facial bone structure physiognomy, to allow secure access to confidential databases and transaction capabilities, e.g., e-banking and brokerage activities. The camera has several focal distances: (a) 12-24 inches for videoconferencing, and (b) 6-12 inches for facial bone structure physiognomy recognition, and (c) 1-6 inches for iris scan. Personal biometric identification features are maintained on a central database, embedded in a microchip installed in the device, or other electronic medium. The computer has a port to connect with a satellite telephone unit to permit transmission of communications, including videoconferencing and biometric feature identification, via satellite.

Another aspect of the invention is a desktop device utilizing biometric iris identification and authentication for credit card, bank card or smart card transactions. The device may be connected into a point of sale system. The first camera is used for video conferencing. The second camera is used for iris recognition. The iris camera captures the pattern of the iris. The captured image is processed into an iris pattern code. The code is checked against a pre-stored code to authenticate the user. The first camera has focal distances 12-24 inches for videoconferencing. The second camera has focal distances of 6-12 inches for facial bone structure physiognomy recognition, and 1-6 inches for iris scan.

Another aspect of the invention is a portable device that may be used at airports, check points, security zones or carried by patrol police. The device has a built-in camera that captures the pattern of the iris. The captured image is then processed into an iris pattern code. The code is matched against a pre-stored code to authenticate the person. The device may have a resident database with iris pattern codes for individuals. Additionally, the portable device may be connected to a network or through wireless communications such as cellular telephony or satellite communications to access a remote database. The camera has focal distances of 6-12 inches for facial bone structure physiognomy recognition, and 1-6 inches for iris scan.

Another aspect of the invention is a computer keyboard that has two built-in cameras. One camera is used as a video conferencing camera. The other camera is an iris identification camera. The first camera has focal distances 12-24 inches for videoconferencing. The second camera has focal distances of 6-12 inches for facial bone structure physiognomy recognition, and 1-6 inches for iris scan. The iris camera captures the pattern of the human iris. The captured image is processed into a numeric or alphanumeric iris pattern code. The iris pattern code is checked against a pre-stored iris pattern code at the computer or at a smart card. The keyboard has a smart card reader. The computer keyboard may utilize a combination camera that provides for video conferencing and iris recognition. The keyboard is attached to a computer which processes the iris pattern of the eye.

Another aspect of the invention is a computer monitor or display device with two built-in cameras. The first camera is used for video conferencing. The second camera is used for iris recognition. The first camera has focal distances 12-24 inches for videoconferencing. The second camera has focal distances of 6-12 inches for facial bone structure physiognomy recognition, and 1-6 inches for iris scan. The camera used for iris identification captures the pattern of the iris. The captured image is processed into an iris pattern code. The code is checked against a pre-stored code to authenticate the user. The computer monitor or display device may utilized a combination camera that provides for video conferencing and iris recognition.

The inventive devices have particular utility for use with networked applications, especially with Internet-based applications. For example, an Internet application may require authentication of a user by biometric means, with the devices discussed herein, the user of a device may readily scan his iris pattern and submit a generated iris pattern code to the networked application. The networked application use that iris pattern code to determine access and authorization for security purposes. The application may store an second iris pattern code remotely and non-accessible by the user. The networked application may then compare the generated iris pattern code with the remotely stored iris pattern code. Upon verification of a match, then the networked application may provide authorized access. The verification for example may be used to verify identity before authorizing a financial transaction, such as a credit card or electronic funds transfer.

The iris scan camera as used with the devices described herein, preferably adjusts the focus of the camera to obtain a clear reading of the iris. However, a manual focus camera may also may utilized.

Another aspect of the invention is a biometric identification system including a computer processing unit coupled with an iris scanning camera. A magnetic card reader is coupled with the computer processing unit for reading a first iris pattern code stored on a magnetic card. The computer processing unit is configured (in other words pre-programmed) to process the image of an iris of a person to generate a second iris pattern code. The image of the person's eye is obtained from the iris scanning camera. The computer processing unit is configured to compare the first iris pattern code with the second iris pattern code to determine if a match exists between the new iris pattern code and the one or more iris pattern codes.

Another aspect of the invention is a biometric identification system including a computer processing unit coupled with an iris scanning camera. A database is coupled with the computer processing unit. The database is populated with one or more iris pattern codes of individuals. The computer processing unit is programmed to process an image (obtained through the camera) of an iris of a person to generate a new iris pattern code. The computer processing unit is configured to compare the new iris pattern code with the one or more iris pattern codes housed on the database to determine if a match exists between the new iris pattern code and the one or more iris pattern codes.

Another aspect of the invention is a method of biometric identification. The method includes storing a first iris pattern code on a magnetic media, converting an image of a person's iris to a second iris pattern code, and comparing the first iris pattern code with the second iris pattern code to determine if a match exists between the first iris pattern code and the second iris pattern code. The first iris pattern code is preferably encrypted such that no one can tamper with the code. The first iris pattern code may be stored on and read from a smart card, other electronic media or a database of one or more iris pattern codes.

Accordingly, one many objects of the invention is to identify the iris of an individual to determine their identification utilizing a portable communications device, such as a cellular telephone, or a portable computer.

It is yet another object of the invention to perform iris identification in remote locations.

Another object of the invention to provide a portable communications device or portable computer that allows for video-conferencing, and personal identification through biometric features.

### BRIEF DESCRIPTION OF THE DRAWINGS

A better understanding of the invention can be obtained from the detailed description of exemplary embodiments set forth below, when considered in conjunction with the appended drawings, in which:

FIG. 1 is an illustration of a portable biometric identification device having a camera for personal identification through biometric features;

FIG. 2 is an illustration of a portable computer having a camera for video-conferencing, and personal identification through biometric features;

FIG. 3 is an illustration of a keyboard having a camera for video-conferencing, and personal identification through biometric features; and

FIG. 4 is an illustration of a self-contained unit for personal identification through biometric features; and

FIG. 5 is an illustration of a monitor having a camera for video conferencing, and personal identification through biometric features.

### DETAILED DESCRIPTION

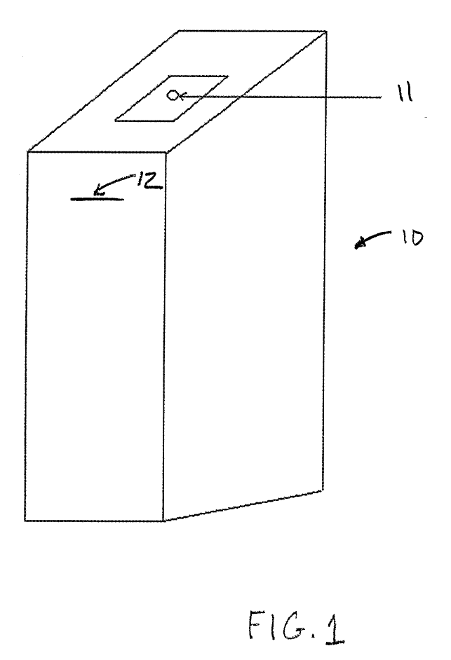

FIG. 1 is an illustration of a portable biometric identification device having a camera for personal identification through biometric features. The biometric identification device 10 has an digital camera for iris recognition 11. A central processing unit is coupled to the digital camera. The portable device may have software for translating the image of the iris to a iris pattern code stored in firmware (such a microchip) or a hardrive on the unit. This desktop/counter-top device is especially useful for credit card, bank card or smart card transactions utilizing biometric iris identification and authentication. The device may be connected into a point of sale system. The digital camera for iris recognition 11 is preferably positioned at the top portion of the body of the portable device. The device for example may be positioned on a counter-top and a person whose identity is to be authenticated peers into the camera. The angle of the camera may be repositioned to accommodate different heights of persons peering into the camera. The device has one or more ports to allow for connection to a point of sale system. Additionally, the portable device has a card reading device 12 to allow reading of an iris pattern code from a smart card or other card that allows for the storing of magnetic or optical data.

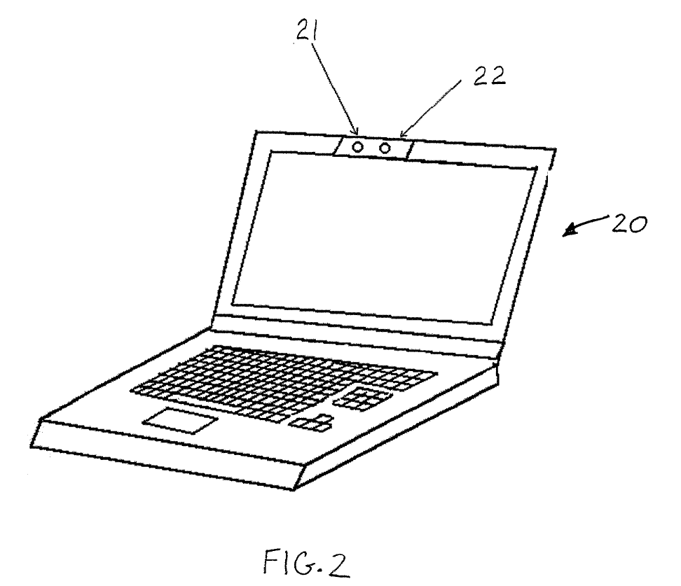

FIG. 2 is an illustration of a portable computer (more commonly referred to as a laptop) 20 having a camera that allows for video-conferencing 21, and a camera 22 used for personal identification through biometric features. The improved portable computer 20 provides for easy biometric identification and video-conferencing. The video-conferencing camera 21 and digital camera for iris recognition 22 also may combined in a single unit. The video-conferencing camera 21 captures video streams and images of the user of the laptop. This allows for video communication with an intended recipient. The digital camera for iris recognition 22 scans the pattern of the iris. The laptop can be configured such that use of the laptop is limited to an individual having an authorized iris pattern code. The iris pattern code may be stored on a portable computer resident-database or chip embedded in the laptop. Likewise, the iris pattern code may be remotely stored and accessible if the laptop has wireless communication functionality, such as a PC card for cellular communications or a connection for satellite telephony. If the portable computer is network accessed, access to the computer network may be limited to those users having authenticated iris pattern codes. The cameras are preferably positioned at the top of the screen. This allows the user to move the screen to the appropriate angle for iris scanning.

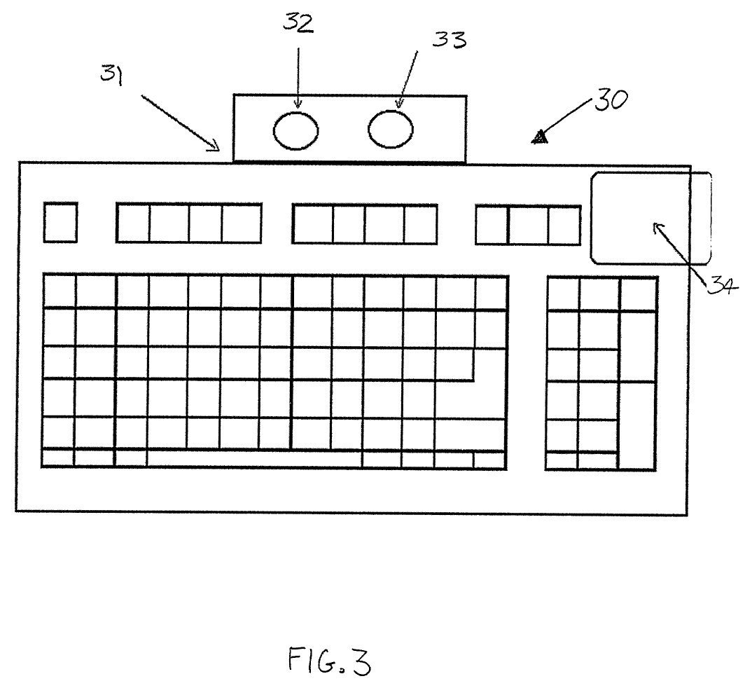

FIG. 3 is an illustration of a keyboard having a camera for video-conferencing, and personal identification through biometric features. The video-conferencing camera 33 and digital camera for iris recognition 32 also may be combined in a single unit. The keyboard 30 has a digital camera for iris recognition 32 and a camera 33 for video-conferencing. An adjustable platform 31 allows the keyboard user to adjust the angle of the platform 31 and cameras. Additionally, the keyboard 20 has a card reader 34 for reading a smart card or other digital card having an iris pattern code stored therein. The keyboard can be interfaced with a computer thereby providing a convenient way to provide a way to enable the CPU with iris authentication. The keyboard has a cable for connecting the keyboard to a computer. The cable may be a USB cable, serial cable, or other interface cable providing transmission of the video information to a computer.

For example, the operating system of the interfaced CPU may employ security software to require authentication of the user by iris authentication. A image obtained by the digital camera for iris recognition is processed by the CPU which generates an iris pattern code. The generated iris pattern code may then be authenticated with an iris pattern code stored on a database accessible by the CPU or other electronic media or other storage devices. Additionally, the iris pattern code may be stored on a smart card. The CPU may uses the stored iris pattern code to authenticate the user.

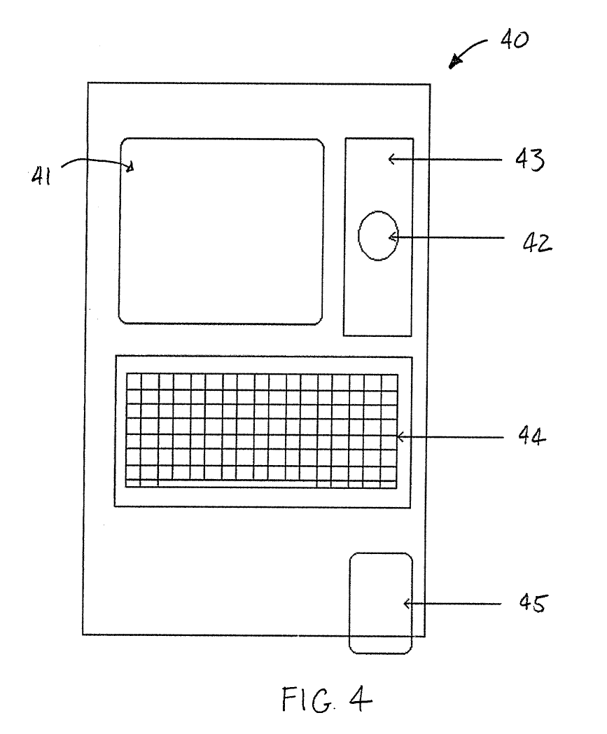

Now referring to FIG. 4, a self-contained unit for personal identification through biometric features is illustrated. The self-contained unit 40, has a display device 41, and adjustable holder 43 holding a digital camera for iris recognition 42, a manual input device (as shown a keyboard) 44, and a electronic card reader 45 (as shown a smart card reader). The devices are coupled to a central processing unit. A resident database may be interfaced to the central processing unit. Likewise the self-contained unit may employ wireless communications, such as cellular or wireless telephony for access to remote databases. This device is especially useful for setting up security checkpoints. For example, a resident database may be populated with iris pattern codes associated with information about individuals. Any person passing through the security checkpoint must be authenticated. The device will read the iris pattern of an individual and convert it to an iris pattern code. If the iris pattern code does not match those iris pattern codes on the database, then the person is not authorized to pass the security checkpoint.

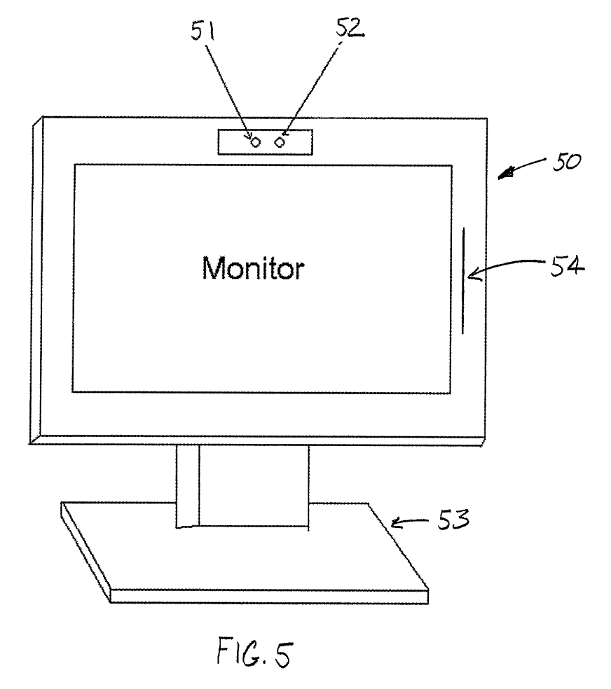

FIG. 5 is an illustration of an improved monitor having a camera for video-conferencing, and personal identification through biometric features. The monitor 50 has a digital camera for iris recognition 52 and a camera 51 for video-conferencing. The video-conferencing camera 51 and digital camera for iris recognition 52 also may combined in a single unit. A flat LCD screen monitor 50 with a stand 53 is illustrated in FIG. 5, but any monitor size or type may be used. The cameras are moveable to allow adjustment of the orientation and angle of the cameras. Additionally, the monitor may have for a smart card reader or other digital card reader 54 to read a card having an iris pattern code stored therein. The monitor can be interfaced with a computer thereby providing a convenient way to provide iris authentication. The monitor 50 has a cable for connecting the monitor 50 to a computer. The cable may be a USB cable, serial cable, or other interface cable providing transmission of the video information to a computer.

For example, the operating system of the interfaced CPU may employ security software to require authentication of the user by iris authentication. The CPU will scan the iris pattern of the user using the digital camera for iris recognition and generate an iris pattern code. The generated iris pattern code may then be authenticated with an iris pattern code stored on a database accessible by the CPU or other electronic media or other storage devices. Additionally, the iris pattern code may be stored on a smart card. The CPU may uses the stored iris pattern code to authenticate the user.

Additionally, the self-contained unit may be used to electronically authenticate the identity of a person holding an identification card. For example, the iris pattern code of a person may be stored on an identification card. The iris pattern code is preferably encrypted such that the iris pattern code on the card can not be manipulated. The iris pattern of the individual is taken by the digital camera for iris recognition 42. The individual inserts the identification card into the electronic card reader 45. The self-contained unit the decrypts the encrypted iris pattern code and compares the stored iris pattern code from the identification card to that of the generated iris pattern code. The self-contained unit indicates whether a match between the code exists.

Moreover, the embodiments described are further intended to explain the best modes for practicing the invention, and to enable others skilled in the art to utilize the invention in such, or other, embodiments and with various modifications required by the particular applications or uses of the present invention. It is intended that the appending claims be construed to included alternative embodiments to the extent that it is permitted by the prior art. For example, in lieu of the biometric features of the iris pattern, one could utilize the facial bone structure physiognomy of a person or use the retnal pattern of a person eye.

What is claimed is:

1. A portable biometric identification device, said device comprising:
a main body,
a central processing unit housed within said body,
a biometric identification camera positioned on the periphery of the main body, said central processing unit coupled with said central processing unit,
wherein said central processing unit is configured to generate an iris pattern code from an image of an iris pattern obtained from said biometric identification camera.

2. The portable biometric device of claim 1, wherein said biometric identification device is configured for video-conferencing.

3. The portable biometric device of claim 2, wherein said camera has a focal distance of between 12 to 24 inches for video conferencing.

4. The portable biometric device of claim 1, wherein said biometric identification device is configured for facial bone structure physiognomy.

5. The portable biometric device of claim 4, wherein the camera has a focal distance of between 6 to 12 inches for facial bone structure physiognomy.

6. The portable biometric device of claim 1, wherein the camera has a focal distance of 1 to 6 inches for an iris scan.

7. The portable biometric device of claim 1, further comprising a database coupled to said central processing unit, said database housing a one or more of iris pattern codes of persons.

8. The portable biometric device of claim 1, further comprising a microchip configured to maintain one or more iris pattern codes for persons.

9. The portable biometric device, further comprising a card reader coupled with said computer processing unit.

10. The portable biometric device, further comprising a wireless communications for accessing a remote database of one or more iris pattern codes.

11. An improved portable computer, comprising:
a body having a central processing unit, a monitor, and a keyboard, said central processing unit coupled with said monitor and keyboard, and
a miniature camera positioned near the monitor,
wherein said portable computer is configured for biometric identification utilizing an iris pattern of the human eye.

12. The improved portable computer of claim 11, wherein said camera has a focal distance of between 12 to 24 inches for video conferencing.

13. The improved portable computer of claim 11, wherein the camera has a focal distance of between 6 to 12 inches for facial bone structure physiognomy.

14. The improved portable computer of claim 11, wherein the camera has a focal distance of 1 to 6 inches for an iris scan.

15. The improved portable computer of claim 11, further comprising a database coupled with said central processing unit, said database housing one or more iris pattern codes.

16. The improved portable computer of claim 11, further comprising a microchip configured to maintain one or more iris pattern codes.

17. The improved portable computer of claim 11, further comprising a transceiver to permit transmission of communications with said portable computer.

18. The improved portable computer of claim 11, further comprising a port for connection to a satellite telephone unit to permit transmission of communications.

19. An improved keyboard, comprising
a body having a plurality of alphanumeric keys, and
an iris recognition camera disposed near the periphery of said body.

20. The improved keyboard of claim 19, further comprising a video-conferencing camera disposed near the periphery of said body.

21. The improved keyboard of claim 20, wherein said video-conferencing camera has a focal distance of between 12 to 24 inches for video conferencing.

22. The improved keyboard of claim 19, wherein the iris recognition camera has a focal distance of between 6 to 12 inches for facial bone structure physiognomy.

23. The improved keyboard of claim 19, wherein the iris recognition camera has a focal distance of 1 to 6 inches for an iris scan.

24. The improved keyboard of claim 19, further comprising a card reader positioned on said body.

25. An improved monitor, comprising
a body having a display for video and graphics;
an iris recognition camera disposed near the periphery of said body.

26. The improved monitor of claim 19, further comprising a video-conferencing camera disposed near the periphery of said body.

27. The improved monitor of claim 20, wherein said video-conferencing camera has a focal distance of between 12 to 24 inches for video conferencing.

28. The improved monitor of claim 19, wherein the iris recognition camera has a focal distance of between 6 to 12 inches for facial bone structure physiognomy.

29. The improved monitor of claim 19, wherein the iris recognition camera has a focal distance of 1 to 6 inches for an iris scan.

30. The improved keyboard of claim 19, further comprising a card reader positioned on said body.

31. A biometric identification system, comprising:
a computer processing unit coupled with an iris scanning camera, and
a magnetic card reader coupled with said computer processing unit for reading a first iris pattern code stored on a magnetic card,
wherein said computer processing unit is configured to process the image of an iris of a person to generate a second iris pattern code, and
wherein said processing unit is configured to compare the first iris pattern code with the second iris pattern code to determine if a match exists between the new iris pattern code and the one or more iris pattern codes.

32. A biometric identification system, comprising:
a computer processing unit coupled with an iris scanning camera, and
a database coupled with said computer processing unit, said database housing one or more iris pattern codes,
wherein said processing unit is configured to process an image of an iris of a person to generate a new iris pattern code, and
wherein said computer processing unit is configured to compare the new iris pattern code with the one or more iris pattern codes housed on the database to determine if a match exists between the new iris pattern code and the one or more iris pattern codes.

33. A method of biometric identification, comprising:
storing a first iris pattern code on a magnetic media,
converting an image of a person's iris to a second iris pattern code, and
comparing the first iris pattern code with the second iris pattern code to determine if a match exists between the first iris pattern code and the second iris pattern code.

34. The method of biometric identification of claim 33, wherein the first iris pattern code is encrypted.

35. The method of biometric identification of claim 33, further comprising reading the first iris pattern code from a smart card.

36. The method of biometric identification of claim 33, further comprising reading the first iris pattern code from a database housing a plurality of iris pattern codes.

37. The method of biometric identification of claim 33, further comprising storing a plurality of iris pattern codes for individuals in a database.

38. The method of biometric identification of claim 33, further comprising associating personal information about a person to the second iris pattern code.
